(19) United States
(12) Patent Application Publication
(10) Pub. No.: US 2024/0062750 A1
(43) Pub. Date: Feb. 22, 2024

(54) SPEECH TRANSMISSION FROM A TELECOMMUNICATION ENDPOINT USING PHONETIC CHARACTERS

(71) Applicant: Avaya Management L.P., Durham, NC (US)

(72) Inventors: Paul Roller Michaelis, Louisville, CO (US); Sudhir Nivrutti Shelke, Pune (IN); Aonkar Balkrushna Takalikar, Pune (IN)

(21) Appl. No.: 17/890,454

(22) Filed: Aug. 18, 2022

(51) Int. Cl. G10L 15/183; G10L 15/26

(52) U.S. Cl. CPC G10L 15/183; G10L 15/26

(57) ABSTRACT

The technology disclosed herein enables speech transmission from a telecommunication endpoint using phonetic characters. In a particular embodiment, a method includes receiving audio including speech captured from a user at a first endpoint. The method further includes translating the speech to a string of phonetic characters and transmitting the string to a second endpoint. The second endpoint generates recreated audio of the sounds represented by the string.

### TECHNICAL BACKGROUND

Many factors may cause the quality of voice telecommunication to degrade. Examples include poor wireless connections and network congestion. When factors such as these cause the quality of voice communication to be poor, non-voice data may still be transmitted reliably. A reason is that real-time voice telecommunication, which commonly uses the User Datagram Protocol (UDP) transmission method, becomes unusable with relatively low levels of packet loss. In contrast, non-voice data (i.e., data not carrying real-time voice communications) are transmitted using the Transmission Control Protocol (TCP) method, which ensures that all transmitted packets are received reliably (albeit with occasional pauses and delays that do not occur with UDP). The transmission of voice packets via TCP rather than UDP during periods of network congestion is not an acceptable solution to poor-quality voice communication because it would increase the required number of bits-per-second, thereby making the congestion even worse.

### SUMMARY

The technology disclosed herein enables speech transmission from a telecommunication endpoint using phonetic characters. In a particular embodiment, a method includes receiving audio including speech captured from a user at a first endpoint. The method further includes translating the speech to a string of phonetic characters and transmitting the string to a second endpoint. The second endpoint generates recreated audio of sounds represented by the string.

In some examples, the method includes, before transmitting the string, determining that audio quality of a communication channel with the second endpoint does not satisfy a quality criterion. In those examples, the method may include, before determining that the audio quality does not satisfy the quality criterion, receiving prior audio captured from the user and transmitting the prior audio over the communication channel to the second endpoint.

In some examples, the second endpoint stores the string and, upon receiving a request to playback the recreated audio, plays the recreated audio to a second user at the second endpoint.

In some examples, the method includes determining that the user has a first accent that is different from a second accent of a second user of the second endpoint and changing one or more of the phonetic characters to adjust the sounds from the first accent to the second accent. In those examples, determining that the user has the first accent that is different from the second accent may include receiving a user instruction to enable adjusting the sounds from the first accent to the second accent.

In some examples, transmitting the string includes transmitting each of the phonetic characters in real-time.

In some examples, the phonetic characters are characters in the International Phonetic Alphabet.

In some examples, receiving the audio includes receiving the audio over a communication channel with the first endpoint.

In some examples, receiving the audio includes capturing the speech at the first endpoint.

In another example, an apparatus is provided having one or more computer readable storage media and a processing system operatively coupled with the one or more computer readable storage media. Program instructions stored on the one or more computer readable storage media, when read and executed by the processing system, direct the apparatus to receive audio including speech captured from a user at a first endpoint. The program instructions further direct the apparatus to translate the speech to a string of phonetic characters and transmit the string to a second endpoint. The second endpoint generates recreated audio of sounds represented by the string.

### BRIEF DESCRIPTION OF THE DRAWINGS

FIG. 1 illustrates an implementation for transmitting speech from a telecommunication endpoint using phonetic characters.

FIG. 2 illustrates an operation to transmit speech from a telecommunication endpoint using phonetic characters.

FIG. 3 illustrates an operational scenario for transmitting speech from a telecommunication endpoint using phonetic characters.

FIG. 4 illustrates an implementation for transmitting speech from a telecommunication endpoint using phonetic characters.

FIG. 5 illustrates an operational scenario for transmitting speech from a telecommunication endpoint using phonetic characters.

FIG. 6 illustrates an operation to transmit speech from a telecommunication endpoint using phonetic characters.

FIG. 7 illustrates a computing architecture for transmitting speech from a telecommunication endpoint using phonetic characters.

### DETAILED DESCRIPTION

The phonetic translators described herein convert speech to a string of characters before transmitting the string over a communication link with another endpoint. In particular, the string of characters is a string of phonetic characters that represent the sounds of speech. Unlike traditional speech to text processes, translating speech into phonetic characters is performed independent of what language is actually being spoken. Speech to text requires knowledge of what is being spoken to identify a word being said. In contrast, by using phonetic characters, individual sounds are recognized regardless of any spoken word (no matter the language) created by the sounds individually or in combination. The difference in the number bits required to represent the phonetic characters of a spoken word is negligible relative to the number of bits required to represent text characters used to spell the word. Thus, situations where text strings generated from using speech-to-text are transmitted would be equally suited to transmitting strings of phonetic characters. Although, a string of phonetic characters has the added benefit of not requiring speech to text in the language being spoken.

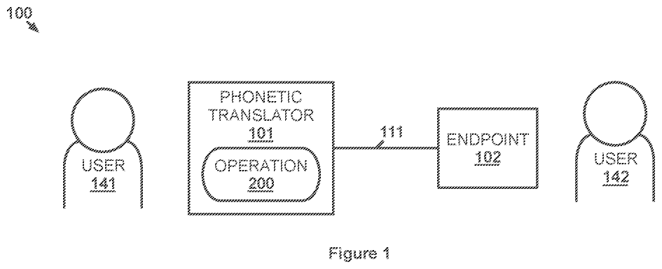

FIG. 1 illustrates implementation 100 for transmitting speech from a telecommunication endpoint using phonetic characters. Implementation 100 includes phonetic translator 101 and endpoint 102. Phonetic translator 101 and endpoint 102 communicate over communication link 111. Communication link 111 is shown as a direct link but may include intervening systems, networks, and/or devices. While phonetic translator 101 is shown with user 141 and endpoint 102 is shown with user 142, neither phonetic translator 101 nor endpoint 102 need be operated by a user. Phonetic translator 101 may not be an endpoint in some examples but, rather, a remote system from two endpoints.

In operation, endpoint 102 may be a telephone, tablet computer, laptop computer, desktop computer, conference room system, voicemail system, Interactive Voice Response (IVR) system, or some other type of computing device. Phonetic translator 101 may be a telephone, tablet computer, laptop computer, desktop computer, conference system, application server, or some other type of computing device. Phonetic translator 101 performs operation 200 as described below to transmit strings of phonetic characters generated from speech of user 141 to endpoint 102. The strings use less bandwidth for transmission that does transmitting audio captured of the speech.

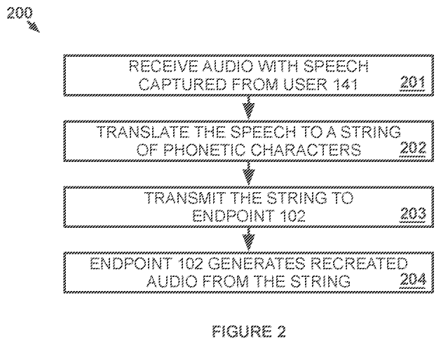

FIG. 2 illustrates operation 200 to transmit speech from a telecommunication endpoint using phonetic characters. In operation 200, phonetic translator 101 receives audio including speech captured from user 141 (201). Phonetic translator 101 may receive the audio by capturing the sound of the speech from user 141 and generated the audio itself. For example, phonetic translator 101 may be an endpoint and may capture speech from user 141 using a microphone built into phonetic translator 101 or otherwise connected to phonetic translator 101 (e.g., a headset worn by user 141). Alternatively, phonetic translator 101 may receive the audio from an endpoint that captured the sound of the speech from user 141. The audio may be analog or digital audio transmitted to phonetic translator 101 from the capturing endpoint over a communication link similar to communication link 111.

Phonetic translator 101 translates the speech in the audio to a string of phonetic characters (202). The phonetic characters may be those defined by the International Phonetic Alphabet (IPA) or may use some other phonetic alphabet. Phonetic translator 101 processes the sounds in the order in which they were spoken by user 141 in the audio and adds a corresponding phonetic character to the string in the same order. For example, speaking the word “hello” may be translated to “ [symbol] ” using the IPA. Although, since different people may pronounce the word differently, the translation may not be the same for all speakers since phonetic translator 101 only translates the actual speech sounds to phonetic characters. For example, some accents may sound as though they are pronouncing the letter “L” using the sound that a native English speaker would associate with the letter “R.” When the translating the word hello spoken by such an accented speaker into the IPA, a character representing the R-sound (or at least what the listener thinks is the R-sound) would be used instead of the character representing the L-sound. In another example, some accents tend to speak the letter “W” with the sound for the letter “V” and phonetic translator 101 will capture the V-sound as spoken for translation to the IPA character for the V-sound. Similarly, even when using the same sounds overall, unlike the above example, different accents may still pronounce words differently (i.e., produce different sounds for the same word). The sounds of any accent user 141 may have are, therefore, represented by the phonetic characters of the string. Phonetic translator 101 may also use one or more characters to represent silence in the speech (e.g., pauses between words). Including silence in the string ensures the speech remains coherent when audio is reproduced from the string (i.e., avoids words melding together). By translating only the sounds made by user 141, the translation performed by phonetic translator 101 is also language agnostic.

Phonetic translator 101 transmits the string to endpoint 102 (203). In some examples, each character of the string may be transmitted in real time as it is translated from the speech. In those examples, the speech may be translated in real time as the audio is received. There may be periods when no character is transmitted due to pauses in the speech. In other examples, the string may be transmitted in its entirety. For example, in a non-real time communication, such as a message from user 141, the audio received by phonetic translator 101 may include speech with the message. The message may be translated to the string of phonetic characters and then transmitted in its entirety. The string may be transmitted using any protocol or convention for transmitting character data.

After receiving the string, endpoint 102 generates recreated audio of the sounds represented by the string (204). Endpoint 102 generates the recreated audio by reproducing the sounds corresponding to each phonetic character in the string. The recreated audio, when played to endpoint 102 (e.g., via a speaker of endpoint 102), reproduces that which was spoken by user 141. In some examples, endpoint 102 receives an indication of vocal frequency ranges of user 141 from the audio of user 141's speech (e.g., phonetic translator 101 may provide the frequency ranges or endpoint 102 may determine the ranges from previously received audio of user 141). The recreated audio may be generated using those frequencies in an attempt to replicate user 141's voice. In other examples, endpoint 102 may synthesize a male or female sounding voice depending on whether user 141 is male or female (e.g., as may be indicated in a message from phonetic translator 101 or determined from previously received audio of user 141) or may depend on a user preference of user 142.

In some examples, the recreated audio may be generated immediately upon receipt of the string and played to user 142. In other examples, endpoint 102 may instruct endpoint 102 to play the recreated audio (e.g., may receive a notification that a message has been received and user 142 may instruct endpoint 102 to playback the message). If user 141 is communicating with user 142 in real time, when a next phonetic character of the string is received, endpoint 102 generates the audio corresponding to that character and plays the sound to user 142. Since the phonetic characters are being generated and transferred by phonetic translator 101 in real time, a next character representing a single spoken word should be received quickly enough to playback immediately following a previously received character for the word. Any pauses in user 141's speech will also be replicated during real time communications because phonetic translator 101 will have to wait for the next sound to be made and endpoint 102 will likewise have to wait for a next character to be received from phonetic translator 101.

Endpoint 102 may also be a system that stores audio. For example, a voicemail system may store a voicemail message from user 141. Endpoint 102 may store the recreated audio for later playback or may store the string instead to reduce the amount of storage space used for the voice message. If only the string is stored, then endpoint 102 may generate the recreated audio once a user, such as user 142, requests playback of the voice message. In another example, endpoint 102 may be an IVR system. Rather than playing back the recreated audio to a user, the IVR system may process the recreated audio to determine responses from user 141 to prompts presented to user 141 by the IVR system. Essentially, the recreated audio may be used in any manner the original audio of speech captured by user 141 would. Using a string of phonetic characters in place of audio reduces the amount of bandwidth needed to transmit/store user 141's speech.

Phonetic translator 101 may perform operation 200 on all voice communications from user 141 (e.g., to reduce the amount of bandwidth used regardless of link conditions) or may perform operation 200 only when link conditions cause audio quality degradation. For example, phonetic translator 101 may determine that communication link 111 does not satisfy a quality criterion (e.g., a packet loss, word loss, or signal noise threshold) for voice communications from user 141. Phonetic translator 101 may then seamlessly transition to translating user 141's speech to a string of phonetic characters for transmission to endpoint 102. In a real-time communication with user 142, user 141 may sound different to user 142 due to user 141's speech being reproduced from recreated audio but users 141 and 142 can carry on with the real-time voice communication despite link conditions not being conducive for transmission of user 141's actual voice. Similarly, while only discussed in one direction, audio from endpoint 102 may be similarly limited. Therefore, endpoint 102 may also employ a phonetic translator to transmit speech captured by endpoint 102 from user 142.

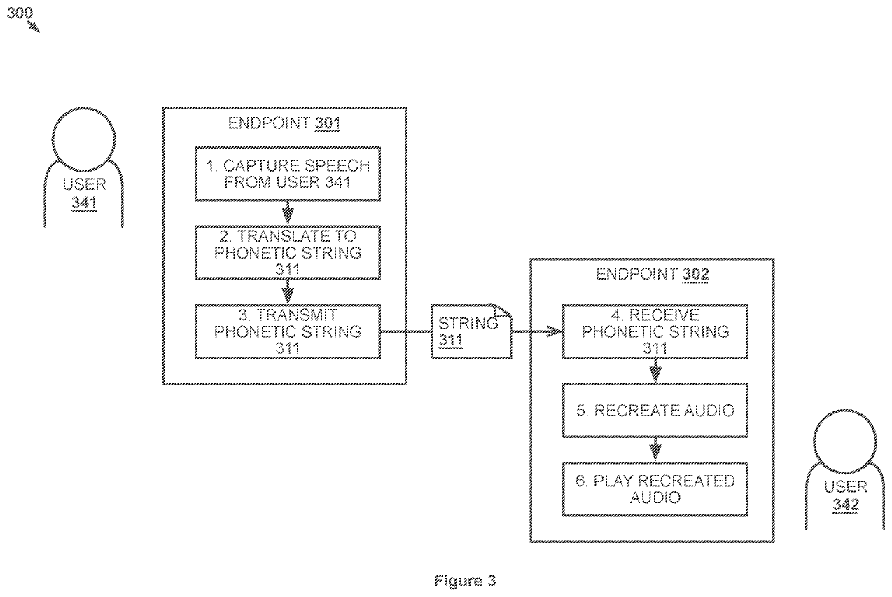

FIG. 3 illustrates operational scenario 300 for transmitting speech from a telecommunication endpoint using phonetic characters. Endpoint 301 is an example where phonetic translator 101 is a telecommunications endpoint along with endpoint 302. Endpoint 301 is operated by user 341 and endpoint 302 is operated by user 342. In this example, user 341 is speaking to user 342 in real-time over a communication session established between endpoint 301 and endpoint 302 (e.g., user 341 and user 342 are having a voice conversation). In some examples, the communication session may initially exchange audio captured from user 341 and user 342 before determining that an audio quality criterion is not being satisfied. In response to the criterion not being satisfied, endpoint 301 proceeds with the steps of operational scenario 300 described below. In other examples, endpoint 301 may perform the steps without initially transmitting the audio (e.g., to conserve bandwidth by default). In yet further examples, strings of phonetic characters may be generated and transmitted along with audio and endpoint 302 can determine whether to present the received audio or present recreated audio from the string (e.g., depending on whether the revised audio satisfies a quality criterion).

In operational scenario 300, endpoint 301 captures speech at step 1 from user 341. User 341 may speak as they normally would when on a real-time voice call with another person. Endpoint 301 translates the speech at step 2 in real time into phonetic-character string 311. That is, whenever a new sound is captured a phonetic character for that sound is immediately added to phonetic-character string 311. Endpoint 301 transmits phonetic-character string 311 at step 3 in real time to endpoint 302. Whenever a new phonetic character is added to phonetic-character string 311 at step 2, endpoint 301 transmits that character to endpoint 302. Endpoint 302 receives phonetic-character string 311 at step 4 and recreates audio of the sounds corresponding to each phonetic character in phonetic-character string 311 at step 5. Endpoint 302 plays the recreated audio at step 6 through a speaker of endpoint 302. Like endpoint 301, which generated and transmitted each character of phonetic-character string 311 in real time, endpoint 302 receives each character in real time and adds to the recreated audio each corresponding sound as the character comes in. The recreated audio is played to user 341 in real time just as though endpoint 302 received the original audio captured from user 341 during a conventional real time voice call. While the sound heard by user 342 is not identical to the sound captured from user 341, the sounds produced are consistent with those spoken by user 341 because endpoint 302 reproduces the sounds made by user 341 rather than simply vocalizing the same words, as may occur had speech to text been used by endpoint 301 to create a transcript rather than endpoint 301 creating phonetic-character string 311.

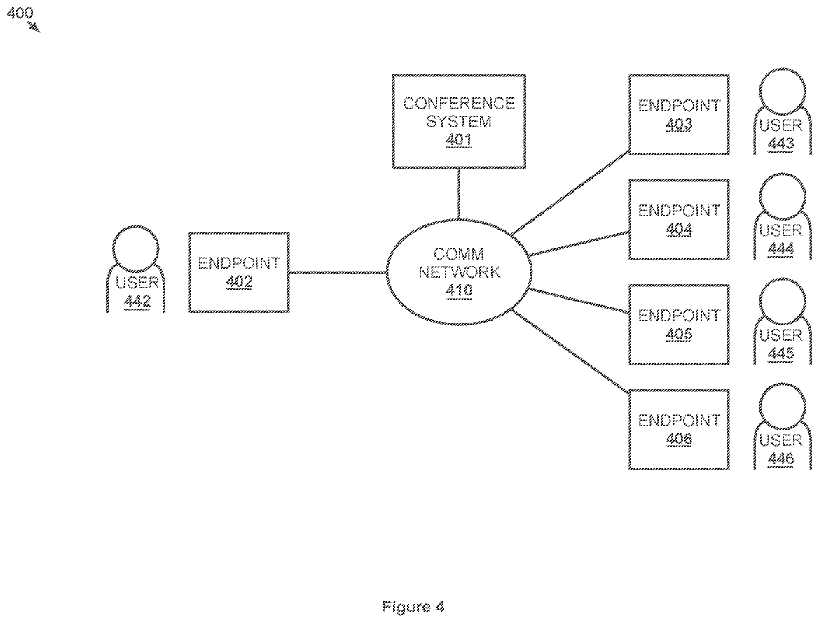

FIG. 4 illustrates implementation 400 for transmitting speech from a telecommunication endpoint using phonetic characters. Implementation 400 includes conference system 401, endpoints 402-406, and communication network 410. Communication network 410 includes one or more local area networks and/or wide area computing networks, including the Internet, over which systems 401-406 communicate. Endpoints 402-406 may each comprise a telephone, laptop computer, desktop workstation, tablet computer, conference room system, or some other type of user operable computing device. Conference system 401 may be an audio/video conferencing server, a packet telecommunications server, a web-based presentation server, or some other type of computing system that facilitates user communication sessions between endpoints. Conference system 401 is an example of phonetic translator 101 being a system other than an endpoint. Endpoints 402-406 each execute a conference client application that enables endpoints 402-406 to join conference sessions facilitated by conference system 401. In this example, endpoints 402-406 are connected on a conference session facilitated by conference system 401. The conference session at least enables real-time voice communications to be exchanged between endpoints 402-406 of their respective users 442-446. Real-time video and other types of media may also be exchanged.

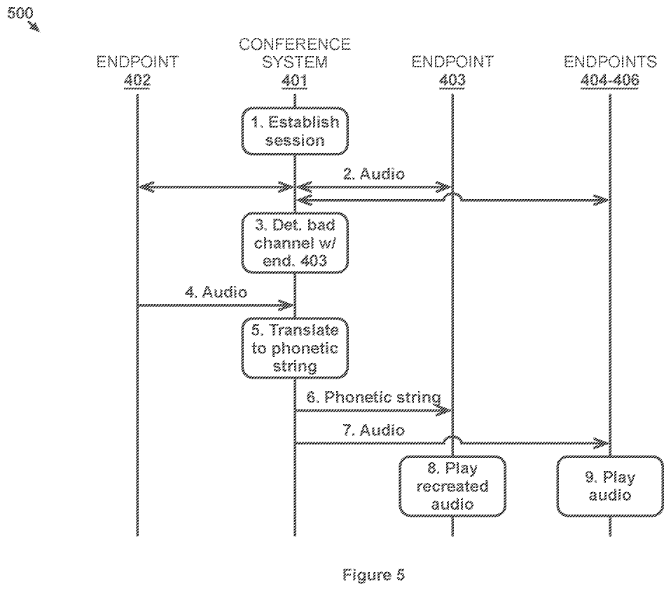

FIG. 5 illustrates operational scenario 500 for transmitting speech from a telecommunication endpoint using phonetic characters. In operational scenario 500, a voice communication session is established at step 1 by conference system 401 between endpoints 402-406 to enable users 442-446 to speak with one another or at least for user 442 to speak with users 443-446. The communication session may be established using any protocol supporting voice communications. Once established, real-time audio is transmitted at step 2 between endpoints 402-406 over communication network 410. The real-time audio includes speech captured of one or more of users 442-446 by their respective endpoints 402-406.

In an ideal situation, the audio quality satisfies a quality criterion for the entirety of the communication session. However, in this example, conference system 401 determines at step 3 that a bad audio channel exists between conference system 401 and endpoint 403. The bad audio channel may be indicated by audio received from conference system 401 at endpoint 403 or from endpoint 403 at conference system 401 failing to satisfy a quality criterion. For example, conference system 401 may determine that amount of packet loss occurring in communications exchanged with endpoint 403 is higher than a desired threshold, which is likely causing user 443 to miss things being said in the audio exchanged over the communication session. In some examples, user 443 may recognize that the audio they are experiencing is below their own desired quality (e.g., user 443 may be having trouble understanding what is being said) and may indicate that a phonetic-character string should be used instead (e.g., may toggle an option in the conference client executing on endpoint 403 to turn on the phonetic translator feature). The bad audio channel may be caused by a bad connection between endpoint 403 and communication network 410, from congestion on a portion of communication network 410 to which endpoint 403 is connections, or from some other factor.

Responsive to identifying the bad channel, conference system 401 determines that audio can no longer be reliably sent to endpoint 403, as was occurring up to that point. In this example, user 442 is the current speaker on the communication session. When conference system 401 receives audio from endpoint 402 carrying speech spoken by user 442, conference system 401 does not transmit that audio to endpoint 403 as would have occurred had the audio channel with endpoint 403 not been bad. Instead, conference system 401 translates the speech at step 5 into a string of phonetic characters in real time. Conference system 401 likewise transmits the generated string at step 6 to endpoint 403 in real time. The string may be transmitted over a data channel for the communication session that is dedicated to transmitting strings or may repurpose another data channel for the communication session (e.g., an out of band control channel). While transmitting the string in real time to endpoint 403, conference system 401 continues to transmit the received audio at step 7 to endpoints 404-406 just as was already occurring at step 2 (i.e., no changes occur with the exchange of voice communications for those endpoints not determined to have bad audio channels).

As endpoint 403 receives the phonetic characters of the string in real time, endpoint 403 generates and playback audio of the sounds represented by those characters at step 8 to user 443. Concurrently, endpoints 404-406 are also playing the real-time audio received from conference system 401 at step 9. Even though user 443 is not hearing user 442's voice like users 444-446, the sounds played by endpoint 403 from the phonetic characters align with the sounds produced by user 442 when speaking (e.g., include any audible artifacts caused by user 442's accent or pronunciation of words). While only speech from user 442 is discussed above, speech from users 444-446 may similarly be translated into a phonetic-character string for transmission to endpoint 403. Further, if conference system 401 detects a bad audio channel with one or more of endpoints 402 and 404-406, conference system 401 may transmit the generated phonetic-character strings to more than just endpoint 403. Also, in this example, conference system 401 handles the generation of the phonetic-character string but, in other examples, endpoint 402 may generate the string and transmit the string to conference system 401 for distribution to endpoints having bad audio channels.

Operational scenario 500 only discusses a string being sent to endpoint 403. However, the bad audio channel with endpoint 403 likely also affects audio being transferred from endpoint 403 to conference system 401. As such, when endpoint 403 captures speech of user 443, endpoint 403 may, in real time, translate that speech into a phonetic-character string and transmit the string to conference system 401. Upon receiving the characters of the string from endpoint 403, conference system 401 likewise recreates audio from the characters and transmits the recreated audio to endpoints 402 and 404-406 where it is played in real time. In some examples, conference system 401 may forward the string itself to endpoints 402 and 404-406 for recreation and playback of the audio in real time.

Also, while it is possible that the bad audio channel condition may remain until endpoint 403 leaves the communication session, the bad audio channel may recover (e.g., the conditions causing the bad audio channel may abate). If conference system 401 determines that the audio channel now satisfies the criterion for transmitting audio, phonetic translator 101 may switch back to sending the actual audio captured from users to endpoint 403. Should the audio channel ever go bad again, conference system 401 will be ready to again switch to using phonetic-character strings instead.

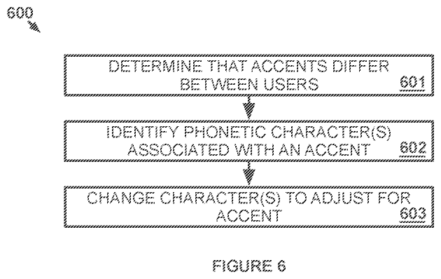

FIG. 6 illustrates operation 600 to transmit speech from a telecommunication endpoint using phonetic characters. Phonetic translator 101 (or endpoint 301/conference system 401) performs operation 600 to account for accent differences between users on a voice communication session. In particular, phonetic translator 101 determines that the accents differ between user 141 and user 142 (601). Phonetic translator 101 may determine that the accents differ by processing the sounds made when each user is speaking and matching those sounds to sounds typically made with certain accents. Phonetic translator 101 may also/instead use geographic locations of user 141 and user 142, demographic information about user 141 and user 142, or some other information that may indicate a user's accent—including combinations thereof. In some examples, one of user 141 and user 142 may indicate to phonetic translator 101 what accent(s) they believe are involved.

Phonetic translator 101 identifies phonetic characters that are associated with the accent of the speaking user, user 141 in this case (602). The identified phonetic characters may represent sounds that are typically made by users having user 141's particular accent while not made by users having user 142's accent. In some examples, phonetic translator 101 may use characters surrounding a particular character, or characters, to determine whether the character(s) should be identified as being associated with the accent of user 141 but not the accent of user 142. For instance, while a sound may be common across multiple accents user 141's accent may only make the sound in relation to the other sounds represented by the surrounding characters. Phonetic translator 101 changes the identified characters to adjust user 141's accent to more closely resemble user 142's accent (603). Phonetic translator 101 may reference a mapping of phonetic characters in user 141's accent to corresponding phonetic characters in user 142's accent. Similar mappings may be used for other accent combinations than that of user 141 and user 142. Alternatively, phonetic translator 101 may employ a neural network that was trained using phrases said in the two different accents. The string may be input into the neural network to output a string with changed characters therein.

In an example, it was mentioned above that some accents may cause the word “hello” to be spoken with the R-sound in the middle rather than the L-sound. While it may sound like the R-sound to a native English speaker, the actual sound is more nuanced and is identified by phonetic translator 101 from the phonetic character(s) representing the sound. Effectively, phonetic translator 101 is recognizing the L-sound made in user 141's accent not what an unknowing listener with a different accent would consider the R-sound, which are represented by different phonetic characters. In another example, in some regions of Japan, the sound made for the letter “F” (as in “Fuji”) is pronounced in a way that may sound to native English speakers like a combination of “F” and “S” sounds, almost as though the speaker is whistling while saying that sound. The IPA uses different characters to represent the Japanese and American F-sounds. If phonetic translator 101 is configured to convert Japanese-style pronunciations of user 141 to American-style of user 142, it would replace the Japanese-style F-sound with the corresponding American-style F-sound.

Phonetic translator 101 may perform the accent adjustment of operation 600 automatically or in response to a user directing phonetic translator 101 to perform the accent adjustment. Either user 141 or user 142 may toggle on the accent adjustment. User 141 may recognize that user 142 is having trouble understanding them and toggle on the feature or user 142 may toggle on the feature in an attempt to better understand user 141. While operation 600 is described with respect to phonetic translator 101 performing the accent adjustment, endpoint 102 may perform the accent adjustment on the string when the string is received from phonetic translator 101. Similarly, the accent adjustment may trigger the use of phonetic-character strings instead of captured audio even in situations where there is no audio quality issue between phonetic translator 101 and endpoint 102. For example, if user 142 is having trouble understanding user 141 based on their accent difference, user 142 may instruct for the accent adjusted character strings to be used instead.

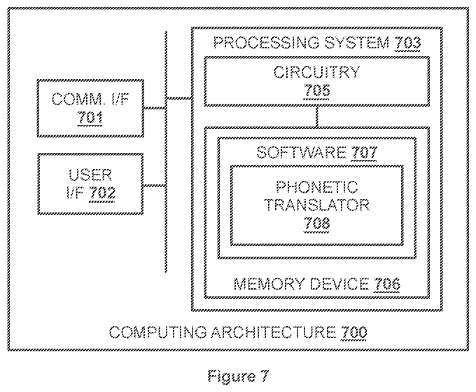

FIG. 7 illustrates computing architecture 700 for transmitting speech from a telecommunication endpoint using phonetic characters. Computing architecture 700 is an example computing architecture for phonetic translator 101, endpoint 301, and conference system 401, although systems 101, 301, and 401 may use alternative configurations. Other systems described above, such as the other endpoints described herein, may also use computing architecture 700. Computing architecture 700 comprises communication interface 701, user interface 702, and processing system 703. Processing system 703 is linked to communication interface 701 and user interface 702. Processing system 703 includes processing circuitry 705 and memory device 706 that stores operating software 707.

Communication interface 701 comprises components that communicate over communication links, such as network cards, ports, RF transceivers, processing circuitry and software, or some other communication devices. Communication interface 701 may be configured to communicate over metallic, wireless, or optical links. Communication interface 701 may be configured to use TDM, IP, Ethernet, optical networking, wireless protocols, communication signaling, or some other communication format—including combinations thereof.

User interface 702 comprises components that interact with a user. User interface 702 may include a keyboard, display screen, mouse, touch pad, or some other user input/output apparatus. User interface 702 may be omitted in some examples.

Processing circuitry 705 comprises microprocessor and other circuitry that retrieves and executes operating software 707 from memory device 706. Memory device 706 comprises a computer readable storage medium, such as a disk drive, flash drive, data storage circuitry, or some other memory apparatus. In no examples would a computer readable storage medium of memory device 706, or any other computer readable storage medium herein, be considered a transitory form of signal transmission (often referred to as “signals per se”), such as a propagating electrical or electromagnetic signal or carrier wave. Operating software 707 comprises computer programs, firmware, or some other form of machine-readable processing instructions. Operating software 707 includes phonetic translator module 708. Operating software 707 may further include an operating system, utilities, drivers, network interfaces, applications, or some other type of software. When executed by processing circuitry 705, operating software 707 directs processing system 703 to operate computing architecture 700 as described herein.

In particular, phonetic translator module 708 directs processing system 703 to receive audio including speech captured from a user at a first endpoint. Phonetic translator module 708 also directs processing system 703 to translate the speech to a string of phonetic characters and transmit the string to a second endpoint. The second endpoint generates recreated audio of sounds represented by the string.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method comprising:
receiving audio including speech captured from a user at a first endpoint;
translating the speech to a string of phonetic characters; and
transmitting the string to a second endpoint, wherein the second endpoint generates recreated audio of sounds represented by the string.

2. The method of claim 1, comprising:
before transmitting the string, determining that audio quality of a communication channel with the second endpoint does not satisfy a quality criterion.

3. The method of claim 2, comprising:
before determining that the audio quality does not satisfy the quality criterion, receiving prior audio captured from the user; and
transmitting the prior audio over the communication channel to the second endpoint.

4. The method of claim 1, wherein the second endpoint stores the string and, upon receiving a request to playback the recreated audio, plays the recreated audio to a second user at the second endpoint.

5. The method of claim 1, comprising:
determining that the user has a first accent that is different from a second accent of a second user of the second endpoint; and
changing one or more of the phonetic characters to adjust the sounds from the first accent to the second accent.

6. The method of claim 5, wherein determining that the user has the first accent that is different from the second accent comprises:
receiving a user instruction to enable adjusting the sounds from the first accent to the second accent.

7. The method of claim 1, wherein transmitting the string comprises:
transmitting each of the phonetic characters in real-time.

8. The method of claim 1, wherein the phonetic characters are characters in the International Phonetic Alphabet.

9. The method of claim 1, wherein receiving the audio comprises:
receiving the audio over a communication channel with the first endpoint.

10. The method of claim 1, wherein receiving the audio comprises:
capturing the speech at the first endpoint.

11. An apparatus comprising:
one or more computer readable storage media;
a processing system operatively coupled with the one or more computer readable storage media; and
program instructions stored on the one or more computer readable storage media that, when read and executed by the processing system, direct the apparatus to:
receive audio including speech captured from a user at a first endpoint;
translate the speech to a string of phonetic characters; and
transmit the string to a second endpoint, wherein the second endpoint generates recreated audio of sounds represented by the string.

12. The apparatus of claim 11, wherein the program instructions direct the apparatus to:
before transmitting the string, determine that audio quality of a communication channel with the second endpoint does not satisfy a quality criterion.

13. The apparatus of claim 12, wherein the program instructions direct the apparatus to:
before determining that the audio quality does not satisfy the quality criterion, receive prior audio captured from the user; and
transmit the prior audio over the communication channel to the second endpoint.

14. The apparatus of claim 11, wherein the second endpoint stores the string and, upon receiving a request to playback the recreated audio, plays the recreated audio to a second user at the second endpoint.

15. The apparatus of claim 11, wherein the program instructions direct the apparatus to:
determine that the user has a first accent that is different from a second accent of a second user of the second endpoint; and
change one or more of the phonetic characters to adjust the sounds from the first accent to the second accent.

16. The apparatus of claim 15, wherein to determine that the user has the first accent that is different from the second accent, the program instructions direct the apparatus to:
receive a user instruction to enable adjusting the sounds from the first accent to the second accent.

17. The apparatus of claim 11, wherein to transmit the string, the program instructions direct the apparatus to:
transmit each of the phonetic characters in real-time.

18. The apparatus of claim 11, wherein the phonetic characters are characters in the International Phonetic Alphabet.

19. The apparatus of claim 11, wherein to receive the audio, the program instructions direct the apparatus to:
receive the audio over a communication channel with the first endpoint.

20. One or more computer readable storage media having program instructions stored thereon that, when read and executed by a processing system, direct the processing system to:
receive audio including speech captured from a user at a first endpoint;
translate the speech to a string of phonetic characters; and
transmit the string to a second endpoint, wherein the second endpoint generates recreated audio of sounds represented by the string.
